(19) United States
(12) Patent Application Publication
(10) Pub. No.: US 2003/0010843 A1
(43) Pub. Date: Jan. 16, 2003

(54) Spraying gun stand

(76) Inventor: Hsing-Mei Liao, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/900,867

(22) Filed: Jul. 10, 2001

(51) Int. Cl. B05B 15/06

(52) U.S. Cl. 239/273; 248/81

(57) ABSTRACT

A spraying gun stand in which the spraying gun has a head section integrally having a pivot seat. A leg support is pivotally inserted in the pivot seat. The leg support by means of its own resilient force clamps the pivot seat. At least one end face of the pivot seat is formed with a lower locating recesses in which the free ends of the leg support are stopped and located when the leg support is downward pivotally rotated to support the spraying gun in a standing state. The end face is further formed with an upper locating recess in which the free ends of the leg support are stopped and located when the leg support is upward pivotally rotated and folded.

### BACKGROUND OF THE INVENTION

The present invention is related to a spraying gun stand in which the head section of the spraying gun integrally has a pivot seat. A leg support is pivotally inserted in the pivot seat so as to support the spraying gun in a standing state.

FIG. 7 shows a conventional spraying gun stand. A seat body 83 is locked at bottom end of the handle 82 of the spraying gun 81. A bracket 84 is pivotally connected with the seat body 83. The seat body 83 has a leaning section 831. The bracket 84 is pivotally rotated to lean on the leaning section 831. Accordingly, by means of the bracket 84, the spraying gun 81 is supported to stand on a plane face.

The seat body 83 is locked at the bottom end of the handle 82. The bracket 84 has a considerably large volume and cannot be located or collapsed. Therefore, in use of the spraying gun 81, the hand of a user will be obstructed and when storing the spraying gun 81, the bracket 84 will occupy much room.

In order to prevent the bracket 84 from interfering with the user's hand, it is necessary to position the seat body 83 and the bracket 84 at other place. For example, the bracket can be rotatably disposed at the adjoining section between the spraying gun 81 and the paint can and the bottom of the bracket is designed with a profile in accordance with the paint can. Accordingly, the bracket can be folded without affecting the operation. However, the adjoining section between the spraying gun 81 and the paint can has an irregular curved face so that it is hard to lock the seat body 83. In the case that the seat body 83 is fixed by clamping, even though the clamping face of the clamp is designed with arched shape, it is still hard to achieve a reliable clamping effect.

### SUMMARY OF THE INVENTION

It is therefore a primary object of the present invention to provide a spraying gun stand in which the spraying gun has a head section integrally having a pivot seat. A leg support is pivotally inserted in the pivot seat. The leg support by means of its own resilient force clamps the pivot seat. At least one end face of the pivot seat is formed with a lower locating recesses in which the free ends of the leg support are stopped and located when the leg support is downward pivotally rotated to support the spraying gun in a standing state.

It is a further object of the present invention to provide the above spraying gun stand in which the end face of the pivot seat is further formed with an upper locating recess in which the free ends of the leg support are stopped and located when the leg support is upward pivotally rotated and folded. The leaning section of the leg support is bent to have an arched shape which is slightly larger than the profile of the paint can. Therefore, when folded, the leaning section of the leg support attaches to the paint can so as to reduce the volume.

The present invention can be best understood through the following description and accompanying drawings wherein:

### BRIEF DESCRIPTION OF THE DRAWINGS

FIG. 1 is a perspective assembled view of the present invention;

FIG. 2 is a sectional view taken along line II-II of FIG. 1;

FIG. 3 is an enlarged view showing the cooperation between the end face of the pivot seat and the leg support of the present invention;

FIG. 4 is a bottom view showing the cooperation between the end face of the pivot seat and the leg support of the present invention;

FIG. 5 shows that the free ends of the lug support of the present invention are stretched open when pivotally rotated;

FIG. 6 is a perspective assembled view of the present invention in which the leg support is folded; and

FIG. 7 shows a conventional spraying gun stand.

### DETAILED DESCRIPTION OF THE PREFERRED EMBODIMENT

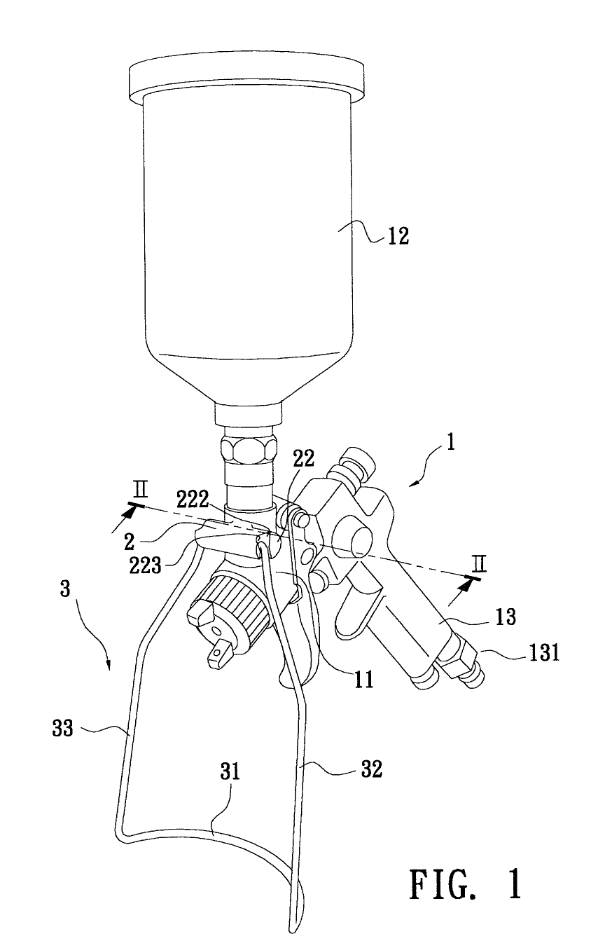

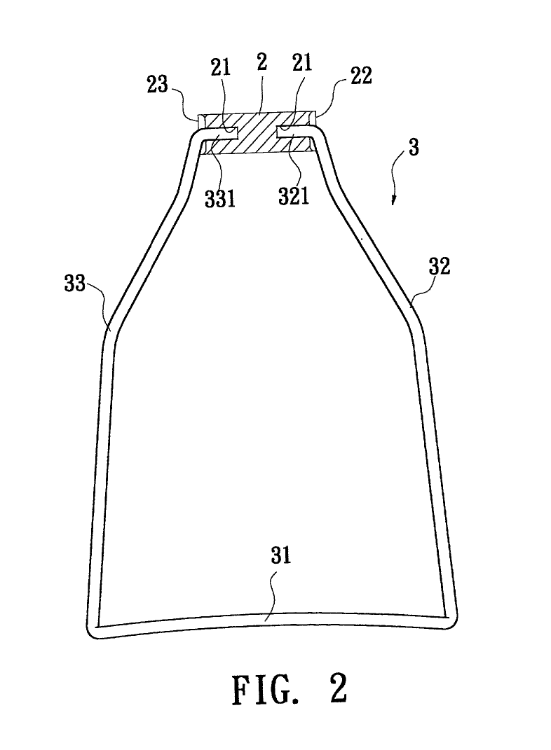

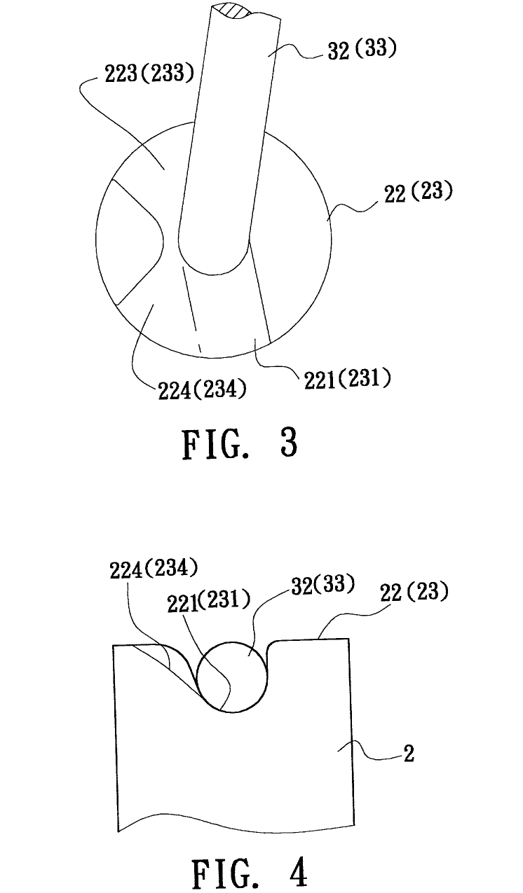

Please refer to FIGS. 1 to 5. The spraying gun 1 of the present invention has a head section 11 integrally having a pivot seat 2. The pivot seat 2 has two end faces 22, 23 each having a hole 21 for a leg support 3 to pivotally insert therein. The leg support 3 has a leaning section 31 which is bent into an arched shape. The arch of the leaning section 31 is slightly larger than the profile of the paint can 12 of the spraying gun 1. The leg support 3 has two free ends 32, 33 respectively extending from two ends of the leaning section 31. The end sections of the free ends 32, 33 are respectively formed with two insertion sections 321, 331 passing through the holes 21 of the pivot seat 2. The leg support 3 by means of its own resilient force clamps the pivot seat 2. The two end faces 22, 23 are respectively formed with two lower locating recesses 221, 231 in which the free ends 32, 33 of the leg support 3 are stopped and located when the leg support 3 is downward pivotally rotated to stand the spraying gun 1. The two end faces 22, 23 are respectively formed with two upper locating recesses 222, 232 in which the free ends 32, 33 of the leg support 3 are stopped and located when the leg support 3 is upward pivotally rotated and folded. When the leg support 3 is upward pivotally rotated and folded, the leaning section 31 gets close to the paint can 12 so as to reduce the volume. The upper locating recesses 222, 232 of the end faces 22, 23 respectively have two first guiding faces 223, 233. When the leg support 3 is downward pivotally rotated, the first guiding faces 223, 233 guide the free ends 32, 33 to leave the upper locating recesses 222, 232. The lower locating recesses 221, 231 respectively have two second guiding faces 224, 234. When the leg support 3 is upward pivotally rotated, the second guiding faces 224, 234 guide the free ends 32, 33 to leave the lower locating recesses 221, 231.

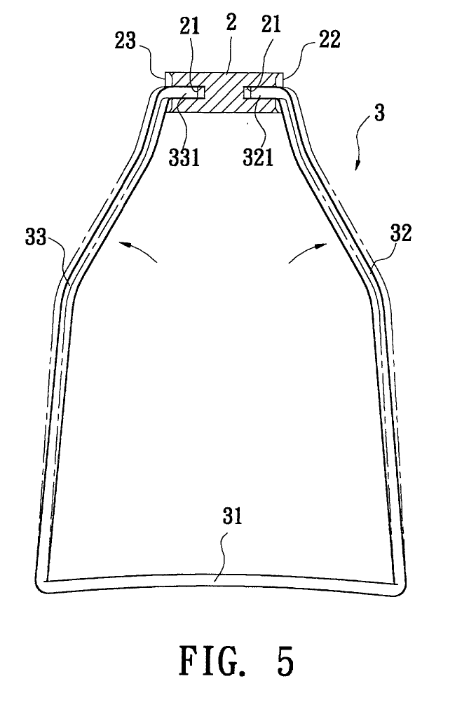

The pivot seat 2 is integrally manufactured with the spraying gun 1 so that the problem of uneasy fixing is avoided. The leg support 3 by means of its own resilient force clamps the pivot seat 2 so that when the leg support 3 is pivotally rotated and the free ends 32, 33 thereof are moved to the upper locating recesses 222, 232 or the lower locating recesses 221, 231, the free ends 32, 33 are resiliently clamped and located therein. Furthermore, the upper locating recesses 222, 232 and lower locating recesses 221, 231 of the end faces 22, 23 respectively have two first guiding faces 223, 233 and two second guiding faces 224, 234. Therefore, when the leg support 3 is pivotally rotated, the first guiding faces 223, 233 and the second guiding faces 224, 234 guide the free ends 32, 33 to outward stretch open as shown in FIG. 5 so as to leave the upper locating recesses 222, 232 and lower locating recesses 221, 231.

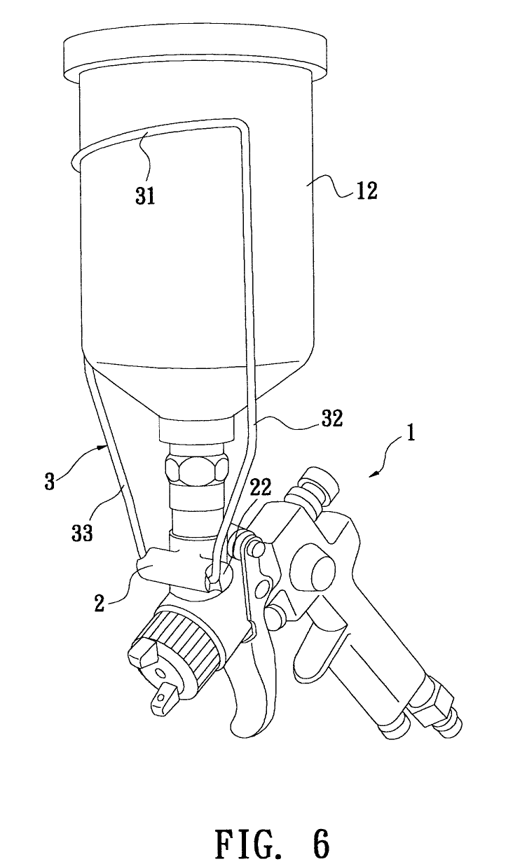

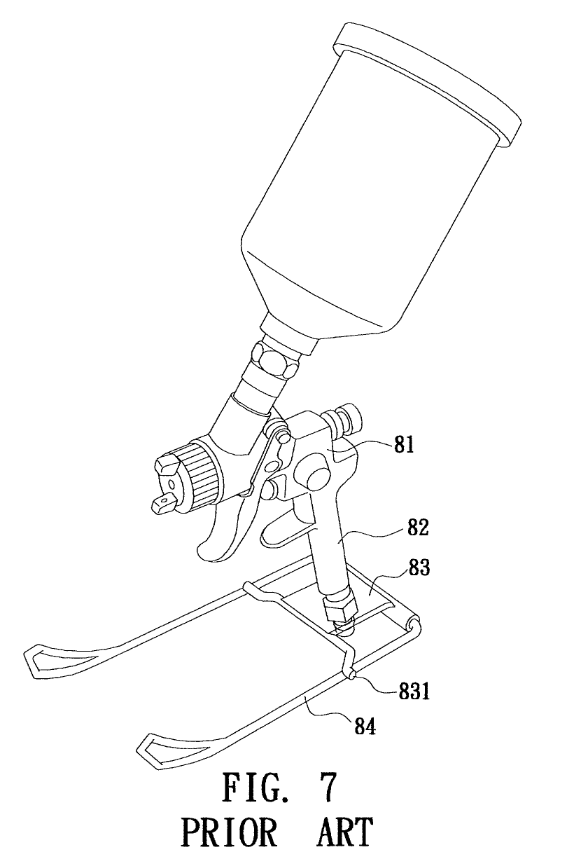

When the leg support 3 is downward pivotally rotated and the free ends 32, 33 thereof are clamped in the lower locating recesses locating recesses 221, 231, the leaning section 31 together with the bottom end 131 of the handle 13 of the spraying gun 1 supports the spraying gun 1 in a standing state as shown in FIG. 1. When using the spraying gun 1, the leg support 3 is upward pivotally rotated and the second guiding faces 224, 234 guide the free ends 32, 33 of the leg support 3 to leave the lower locating recesses 221, 231. Then, the leg support 3 is further upward pivotally rotated and the free ends 32, 33 thereof are clamped in the upper locating recesses 222, 232. The leaning section 31 is slightly larger than the arched shape of the paint can 12 so that the leaning section 31 of the leg support 3 attaches to the paint can 12 as shown in FIG. 6. This reduces the room occupied by the folded leg support 3 so as not to obstruct a user from operating the spraying gun 1.

The above embodiment is only used to illustrate the present invention, not intended to limit the scope thereof. Many modifications of the above embodiment can be made without departing from the spirit of the present invention.

What is claimed is:

1. A spraying gun stand, the spraying gun having a head section integrally having a pivot seat, the pivot seat having two end faces each having a hole for a leg support to pivotally insert therein, the leg support having a leaning section, the leg support having two free ends respectively extending from two ends of the leaning section, the end sections of the free ends being respectively bent and formed with two insertion sections respectively inserted in the holes of the end faces of the pivot seat, the leg support by means of its own resilient force clamping the pivot seat, at least one of the two end faces of the pivot seat being formed with a lower locating recesses in which the free ends of the leg support are stopped and located when the leg support is downward pivotally rotated to support the spraying gun in a standing state, the end face being further formed with an upper locating recess in which the free ends of the leg support are stopped and located when the leg support is upward pivotally rotated and folded.

2. The spraying gun stand as claimed in claim 1, wherein the leaning section of the leg support is bent to have an arched shape which is slightly larger than the profile of the paint can of the spraying gun.

3. The spraying gun stand as claimed in claim 1, wherein the upper locating recess of the end face has a first guiding face, whereby when the leg support is downward pivotally rotated, the first guiding face guides the free ends to leave the upper locating recess.

4. The spraying gun stand as claimed in claim 1, wherein the lower locating recess of the end face has a second guiding face, whereby when the leg support is upward pivotally rotated, the second guiding face guides the free ends to leave the lower locating recess.
